(19) United States
(12) Patent Application Publication
(10) Pub. No.: US 2004/0169879 A1
(43) Pub. Date: Sep. 2, 2004

(54) Image formation device and image formation method

(75) Inventors: Kazuhiro Ichikawa, Nagano-ken (JP); Osamu Ishibashi, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/738,117

(22) Filed: Dec. 18, 2003

(30) Foreign Application Priority Data
Dec. 20, 2002 (JP) 2002-370485

(51) Int. Cl. G06F 15/00

(52) U.S. Cl. 358/1.14; 358/1.8

(57) ABSTRACT

The technique of the invention reads out information on production variance of a secondary transfer unit, which is stored in a storage element of the secondary transfer unit (S100), computes an adjustment value of a control parameter ‘contact timing’, which is related to the operation of the secondary transfer unit, based on the read-out information on production variance (S110), and writes the computed adjustment value into a RAM (S120). The operation of the secondary transfer unit is controlled with the adjustment value of the control parameter ‘contact timing’ written in the RAM.

### BACKGROUND OF THE INVENTION

1. Field of the Invention

The present invention relates to an image formation device and an image formation method. More specifically the invention pertains to an image formation device that forms an image on a recording medium, such as paper, and a corresponding image formation method.

2. Description of the Prior Art

A known image formation device, such as a laser printer or a photocopier, has replaceable units including an image developer unit, a photoreceptor unit, and an exposure unit (for example, Patent Open-Laid Gazette No. 2000-235338). In order to avoid a potential trouble like an operational failure due to a production variance of each unit (for example, a variation in size or a variation in assembly accuracy of each unit), adjustment of the respective units is required in the process of assembly of the units to the image formation device.

The prior art image formation device is, however, often not adjustable to a fully satisfactory level, when replacement of each unit for the purpose of repair or regular maintenance is performed at the location where the image formation device is installed. This may cause an operational failure due to the production variance of each unit.

### SUMMARY OF THE INVENTION

The image formation device and the corresponding image formation method of the invention aim to ensure adequate image formation according to a production variance of a constituent of the image formation device. The image formation device and the corresponding image formation method also aim to reduce the load of adjustment in the case of replacement of a constituent of the image formation device.

In order to achieve at least one aspect of the aforementioned objects, the image formation device and the corresponding image formation method of the invention are structured as follws.

An image formation device of the invention is a device that forms an image on a recording medium, such as paper, and the image formation device includes: an information acquisition module that acquires information on production variance of at least one replaceable key unit included in the image formation device, which is stored in a storage element of the key unit; and a control module that controls an image formation process of forming the image on the recording medium, based on the acquired information on production variance.

The image formation device of the invention controls the image formation process, based on the information on production variance of the key unit, which is read from the storage element of the key unit included in the image formation device. This arrangement effectively ensures adequate image formation according to the production variance of the key unit and thereby desirably reduces the load of adjustment in the case of replacement of the key unit. The ‘information on production variance’ includes a variation in characteristic of the key unit or in characteristic of a constituent of the key unit, a variation in size of the key unit or in size of a constituent of the key unit, and a variation in assembly accuracy of the key unit or in assembly accuracy of a constituent of the key unit.

In the image formation device of the invention, as one aspect, the control module may adjust a control parameter for controlling the image formation process based on the acquired information on production variance, and control the image formation process with the adjusted control parameter.

Further, in the image formation device of the invention, the key unit may include at least one of a charge unit, a photoreceptor unit, an exposure unit, an image developer unit, a transfer unit, a feeder unit, and a fixation unit, and the control module may control an operation of at least one of the key unit, based on information on production variance of the at least one of the key unit. In one application, the key unit may include at least a secondary transfer unit, and the control module may adjust a contact timing of the second transfer unit with an intermediate transfer member, based on information on production variance of the second transfer unit. In this case, the information on production variance may include at least one of a variation in characteristic of the secondary transfer unit, a variation in size of the secondary transfer unit, and a variation in assembly accuracy of the secondary transfer unit. In other case, the information on production variance may include at least one of a variation in characteristic of a constituent of the secondary transfer unit, a variation in size of a constituent of the secondary transfer unit, and a variation in assembly accuracy of a constituent of the secondary transfer unit. In another application, the key unit may include at least an exposure unit, and the control module may adjust an exposure start timing of the exposure unit in a lateral direction, based on information on production variance of the exposure unit. In this case, the information on production variance may include at least one of a variation in characteristic of the exposure unit, a variation in size of the exposure unit, and a variation in assembly accuracy of the exposure unit. In other case, the information on production variance may include at least one of a variation in characteristic of a constituent of the exposure unit, a variation in size of a constituent of the exposure unit, and a variation in assembly accuracy of a constituent of the exposure unit. In another application, the key unit may include at least a fixation unit, and the control module may adjust a flow of electric current applied to a fixation lamp included in the fixation unit, based on information on production variance of the fixation unit. In this case, the information on production variance may include at least one of a variation in characteristic of the fixation unit, a variation in size of the fixation unit, and a variation in assembly accuracy of the fixation unit. In other case, the information on production variance may include at least one of a variation in characteristic of a constituent of the fixation unit, a variation in size of a constituent of the fixation unit, and a variation in assembly accuracy of a constituent of the fixation unit. In still another application, the key unit may include at least one of an image developer unit, a photoreceptor unit, and a transfer unit, and the control module regulates a toner density of a resulting image, based on the acquired information on production variance.

The present invention is structured as an image formation method, as well as an image formation device, that forms an image on a recording medium, such as paper, and the image formation method include the steps of: (a) acquiring information on production variance of at least one replaceable key unit included in an image formation device, which is stored in a storage element of the key unit; and (b) controlling an image formation process of forming the image on the recording medium, based on the acquired information on production variance.

### BRIEF DESCRIPTION OF THE DRAWINGS

FIG. 1 schematically illustrates the structure of a color laser printer 60 in one embodiment of the invention;

FIG. 2 is an enlarged view schematically showing the structure of a secondary transfer unit 67,

FIG. 3 shows an example of information stored in a storage element 78;

FIG. 4 is a block diagram showing functional blocks of a controller 70;

FIG. 5 is a flowchart showing a control parameter setting routine;

FIG. 6 is a plan view illustrating the structure of a transfer belt 64; and

FIG. 7 shows an example of contact timing adjustment value maps.

### DESCRIPTION OF THE PREFERRED EMBODIMENTS

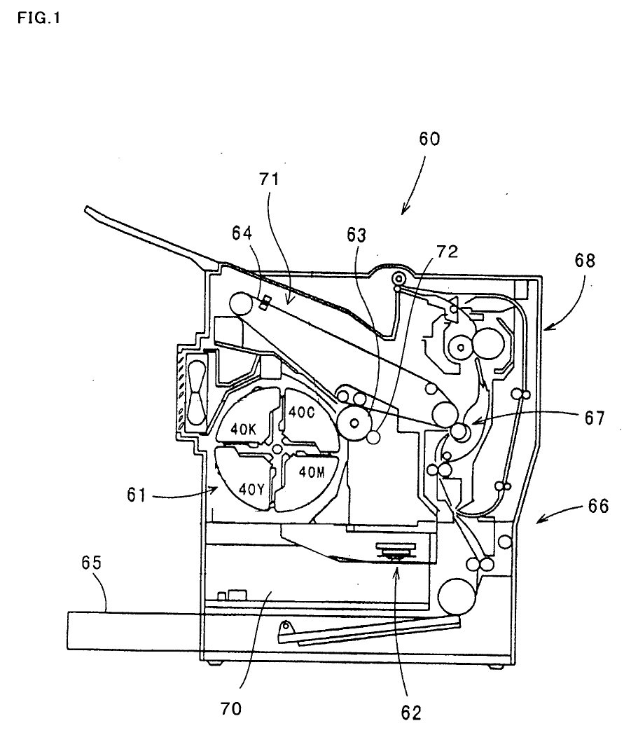

One preferred embodiment of the invention is discussed below. FIG. 1 schematically illustrates the structure of a color laser printer 60 functioning as an image formation device in one embodiment of the invention. The color laser printer 60 of the embodiment is constructed as a full-color electrophotographic image formation device that adopts a single photoreceptor system and an intermediate transfer system. As illustrated, the color laser printer 60 includes a charge roller 72 that charges a photoreceptor 63 to a fixed potential (for example, −700 V), an exposure unit 62 that irradiates the charged photoreceptor 63 with laser and thereby forms color-separated images of four color components, cyan (C), magenta (M), yellow (Y), and black (K), as electrostatic latent images on the photoreceptor 63, and an image developer unit 61 that develops the electrostatic latent images formed on the photoreceptor 63 as toner images of the respective colors with corresponding color toners respectively fed from toner cartridges 40C, 40M, 40Y, and 40K attached to the image developer unit 61. The color laser printer 60 further includes a primary transfer unit 71 that transfers the toner images of the respective colors developed on the photoreceptor 63 onto a transfer belt 64 in an overlapping manner to form a composite color toner image, a feeder unit 66 that conveys printing paper from a paper cassette 65, a secondary transfer unit 67 that further transfers the composite color toner image formed on the transfer belt 64 onto the conveyed printing paper, a fixation unit 68 that fuses and fixes the transferred composite color toner image on the printing paper and delivers the printing paper with the fixed composite color toner image, and a controller 70 that controls all the operations of the color laser printer 60.

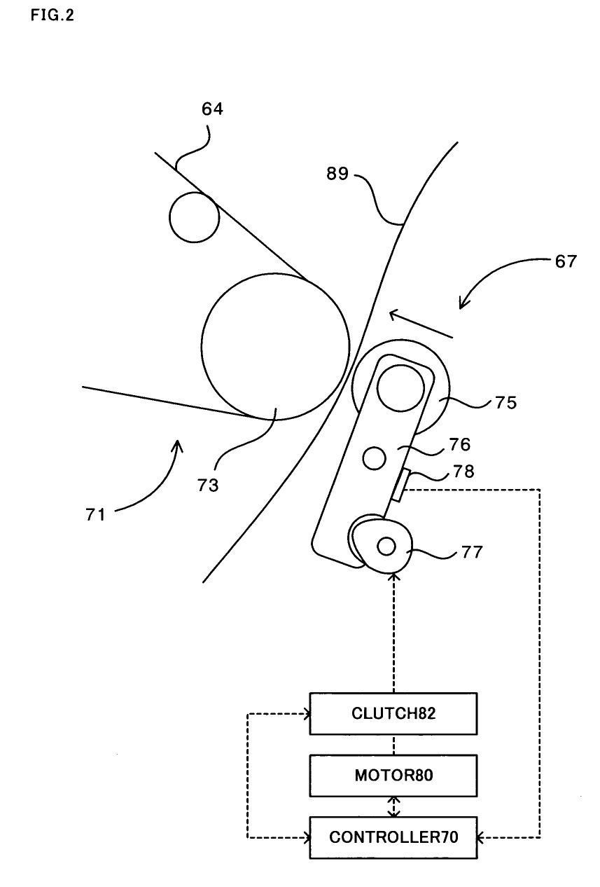

FIG. 2 is an enlarged view schematically showing the structure of the secondary transfer unit 67. As illustrated, the secondary transfer unit 67 includes a secondary transfer roller 75 that is arranged in a rotatable manner to face a backup roller 73 of the primary transfer unit 71, a cam 77 that is rotated by driving force of a motor 80 connecting with the secondary transfer unit 67 via a clutch 82, and a frame 76 that swings the secondary transfer roller 75 toward the backup roller 73 with rotations of the cam 77 to bring the secondary transfer roller 75 into contact with the transfer belt 64. The controller 70 controls the operations of the secondary transfer unit 67. The frame 76 has a storage element 78 that mainly stores information on production variance of the secondary transfer unit 67. The controller 70 reads this information via a non-illustrated input-output interface. In the secondary transfer unit 67 of this structure, the secondary transfer roller 75 is usually apart from the transfer belt 64. The constituents of the secondary transfer unit 67 act in the following manner to transfer the composite color toner image formed on the transfer belt 64 onto a sheet of printing paper 89. An ON operation of the clutch 82 rotates the cam 77 and brings the secondary transfer roller 75 into contact with the transfer belt 64. The pressing force of the secondary transfer roller 75 that is contact with the transfer belt 64 functions to transfer the composite color toner image formed on the transfer belt 64 onto the sheet of printing paper 89.

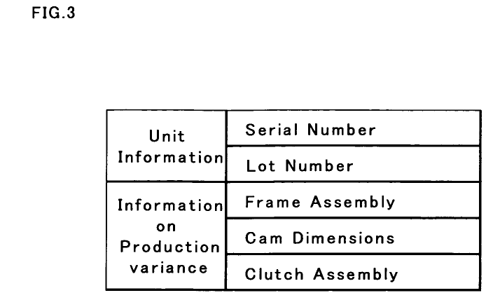

FIG. 3 shows an example of information stored in the storage element 78 of the secondary transfer unit 67. In the structure of this embodiment, unit information of the secondary transfer unit 67 and information on production variance of the secondary transfer unit 67 are stored in the storage element 78. The unit information includes a serial number and a lot number of the secondary transfer unit 67. The information on production variance includes information on an assembly accuracy of the frame 76 (for example, a criterion measure−100 μm), a size of the cam 77 (for example, a criterion measure+75 μm), and an assembly accuracy of the clutch 82 (for example, a criterion measure+8 degrees). These pieces of information are written into the storage element 78, for example, in the process of manufacturing or inspecting the secondary transfer unit 67.

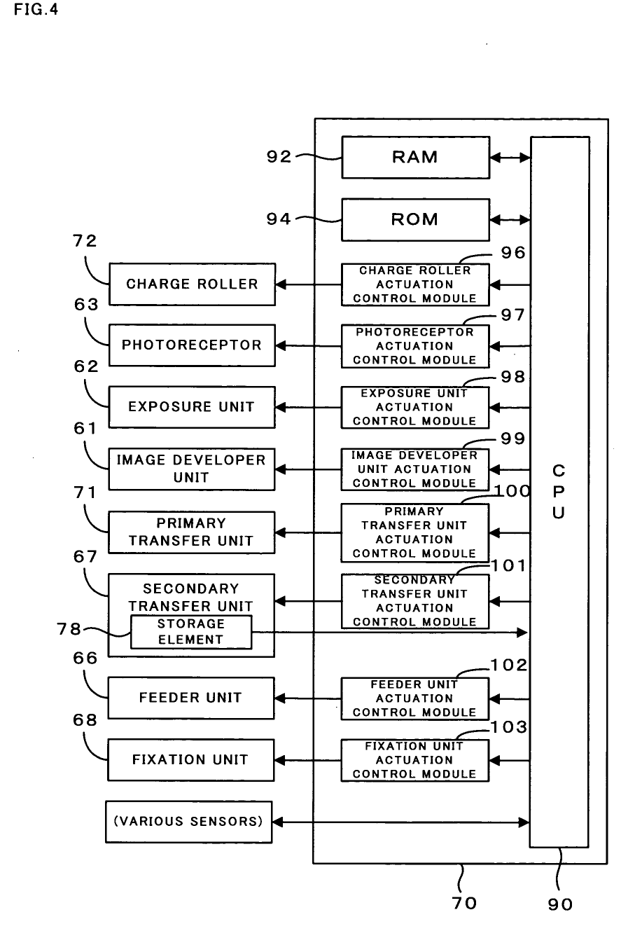

FIG. 4 is a block diagram showing functional blocks of the controller 70. As illustrated, the controller 70 is constructed as a microprocessor including a CPU 90, a RAM 92, and a ROM 94. The controller 70 receives measurement values of various sensors (for example, a temperature sensor), the information read from the storage element 78 of the secondary transfer unit 67, and other input signals (for example, a print instruction signal given by an operator) via signal lines. Based on these input signals, the controller 70 controls the operations of the respective constituents of the color laser printer 60, that is, the charge roller 72, the photoreceptor 63, the exposure unit 62, the image developer unit 61, the primary transfer unit 71, the secondary transfer unit 67, the feeder unit 66, and the fixation unit 68 via a charge roller actuation control module 96, a photoreceptor actuation control module 97, an exposure unit actuation control module 98, an image developer unit actuation control module 99, a primary transfer unit actuation control module 100, a secondary transfer unit actuation control module 101, a feeder unit actuation control module 102, and a fixation unit actuation control module 103. The charge roller 72, the photoreceptor 63, the exposure unit 62, the image developer unit 61, the primary transfer unit 71, the feeder unit 66, and the fixation unit 68 are identical with those included in conventional color laser printers and color photocopiers and are not specifically described here.

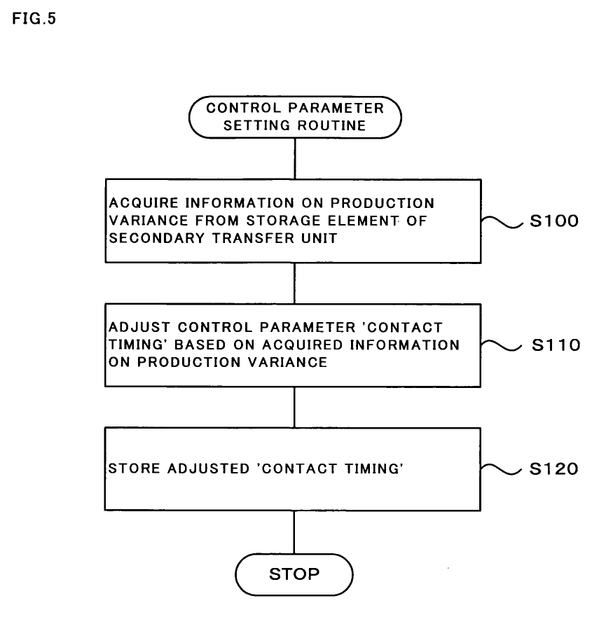

The operations of the color laser printer 60 in the embodiment are discussed below. FIG. 5 is a flowchart showing a control parameter setting routine executed by the controller 70 in response to a power ON operation of the color laser printer 60. When the control parameter setting routine starts, the controller 70 first reads out the information on production variance of the secondary transfer unit 67 stored in the storage element 78 of the secondary transfer unit 67 (step S100). As described above, the information on production variance includes the assembly accuracy of the frame 76, the size of the cam 77, and the assembly accuracy of the clutch 82.

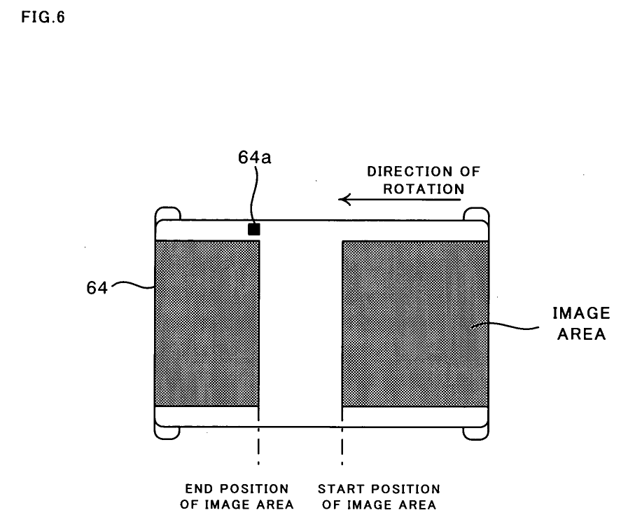

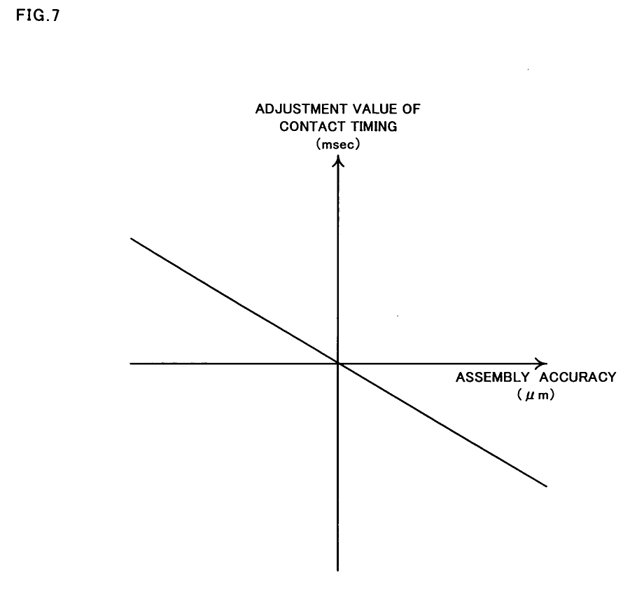

The controller 70 subsequently adjusts a control parameter ‘contact timing’ relating to the operations of the secondary transfer unit 67, among control parameters used to control the process of image formation by the color laser printer 60, based on the acquired information on production variance (step S110). Here the ‘contact timing’ represents an ON timing of the clutch 82 to bring the secondary transfer roller 75 of the secondary transfer unit 67 into contact with the transfer belt 64. As shown in FIG. 6, the secondary transfer unit 67 transfers the composite color toner image, which is formed in an image area on the transfer belt 64 rotating in the direction of an arrow, onto the sheet of printing paper. It is accordingly required to bring the secondary transfer roller 75 into contact with the transfer belt 64, before a start position of this image area on the transfer belt 64 reaches the position of the secondary transfer roller 75. In this embodiment, a standard value of the contact timing is set to a timing when a preset time period (for example, 0.2 sec) has elapsed since detection of a marking 64a provided at an end position of the image area on the transfer belt 64 by a sensor (not shown). The adjustment of the contact timing accordingly adjusts a time period between detection of this marking 64a and an ON operation of the clutch 82. The procedure of this embodiment experimentally or otherwise specifies mappings of the respective values of the information on production variance (the assembly accuracy of the frame 76, the size of the cam 77, and the assembly accuracy of the clutch 82) to the adjustment value of the contact timing (the deviation from the standard value) and stores the mappings as contact timing adjustment value maps in the ROM 94. The adjustment value corresponding to each observed value is read from the corresponding contact timing adjustment value map stored in the ROM 94. FIG. 7 shows an example of such contact timing adjustment value maps with regard to the assembly accuracy of the frame 76. This map is set to shift the contact timing in a negative direction (that is, a direction of shortening the time period between detection of the marking 64a and the ON operation of the clutch 82) with a variation in assembly accuracy of the frame 76 in a positive direction. The greater absolute value of the variation in assembly accuracy leads to the greater absolute adjustment value. Similar maps are prepared with regard to the size of the cam 77 and the assembly accuracy of the clutch 82. The sum of the adjustment values of the respective production variances read from these maps is set to a resulting adjustment value of the contact timing.

The controller 70 writes the computed adjustment value of the contact timing at a predetermined address in the RAM 92 (step S120) and exits from the control parameter setting routine. The process of image formation by the color laser printer 60 refers to the adjustment value written in the RAM 92 according to this control parameter setting routine, so as to regulate the secondary transfer unit 67 to the adjusted contact timing.

As discussed above, the color laser printer 60 of the embodiment acquires the information on production variance stored in the storage element 78 of the secondary transfer unit 67 and adjusts the timing of bringing the secondary transfer roller 75 into contact with the transfer belt 64, based on the acquired information on production variance. This arrangement effectively ensures adequate image formation according to the production variance of the secondary transfer unit 67 and desirably reduces the load of adjustment in the case of replacement of the secondary transfer unit 67.

In the color laser printer 60 of the embodiment, the controller 70 that executes the processing of step S100 corresponds to the information acquisition module of the invention, and the controller 70 that executes the processing of steps S110 and S120 corresponds to the control module of the invention.

The color laser printer 60 of the embodiment adjusts the control parameter ‘contact timing’, based on the information on production variance stored in the storage element 78 of the secondary transfer unit 67. The technique of the invention is also applicable to adjust another control parameter relating to control of any unit other than the secondary transfer unit 67. The storage element for storing the information on production variance is not limited to the secondary transfer unit 67. Another unit may have a storage element, and any of diverse control parameters may be adjusted, based on information on production variance acquired from the storage element. One modification adjusts an exposure start timing of the exposure unit 62 in a lateral direction (side resist correction), based on the assembly accuracy of the exposure unit 62. Another modification adjusts a flow of electric current applied to a fixation lamp, which is used to heat a fixation roller of the fixation unit 68, based on the characteristic (output) of the fixation lamp. Still another modification adjusts a toner density of a resulting image, based on the assembly accuracy of the image developer unit 61, the assembly accuracy of the photoreceptor 63, and the characteristic of the transfer belt 64 (for example, the surface roughness of the transfer belt 64). The adjustment of the toner density is attained by regulating a developing bias of the image developer unit 61, a light exposure of the exposure unit 62, or a charge potential of the charge roller 72 onto the photoreceptor 63. The adjustment target may be a combination of multiple control parameters relating to production variances of the corresponding units. Such combinational adjustment ensures adequate image formation as a whole by the color laser printer 60 in the case of replacement of the respective units. The adjustment of the control parameters is not restrictive at all, but any other suitable method that effectuates control of the color laser printer 60 is applicable.

The color laser printer 60 of the embodiment is constructed as the full-color electrophotographic image formation device that adopts the single photoreceptor system and the intermediate transfer system. The requirement is only to read information on production variation from a storage element of a unit, such as the secondary transfer unit 67. The technique of the invention is thus applicable to color laser printers and color photocopiers constructed as full-color electrophotographic image formation devices that adopt a multi-photoreceptor system and a direct transfer system, as well as to ink jet printers.

The embodiment discussed above regards the color laser printer 60 that forms an image on a recording medium, such as paper. Another application is a corresponding image formation method that forms an image on the recording medium.

The above embodiments are to be considered in all aspects as illustrative and not restrictive. There may be many modifications, changes, and alterations without departing from the scope or sprit of the main characteristics of the present invention. All changes within the meaning and range of equivalency of the claims are therefore intended to be embraced therein.

What is claimed is:

1. An image formation device that forms an image on a recording medium, such as paper, said image formation device comprising:
an information acquisition module that acquires information on production variance of at least one replaceable key unit included in said image formation device, which is stored in a storage element of said key unit; and
a control module that controls an image formation process of forming the image on the recording medium, based on the acquired information on production variance.

2. An image formation device in accordance with claim 1, wherein said control module adjusts a control parameter for controlling the image formation process based on the acquired information on production variance, and controls the image formation process with the adjusted control parameter.

3. An image formation device in accordance with claim 1, wherein said key unit includes at least one of a charge unit, a photoreceptor unit, an exposure unit, an image developer unit, a transfer unit, a feeder unit, and a fixation unit, and
said control module controls an operation of at least one of said key unit, based on information on production variance of said at least one of said key unit.

4. An image formation device in accordance with claim 1, wherein said key unit includes at least a secondary transfer unit, and
said control module adjusts a contact timing of said second transfer unit with an intermediate transfer member, based on information on production variance of said second transfer unit.

5. An image formation device in accordance with claim 4, wherein the information on production variance includes at least one of a variation in characteristic of said secondary transfer unit, a variation in size of said secondary transfer unit, and a variation in assembly accuracy of said secondary transfer unit.

6. An image formation device in accordance with claim 4, wherein the information on production variance includes at least one of a variation in characteristic of a constituent of said secondary transfer unit, a variation in size of a constituent of said secondary transfer unit, and a variation in assembly accuracy of a constituent of said secondary transfer unit.

7. An image formation device in accordance with claim 1, wherein said key unit includes at least an exposure unit, and
said control module adjusts an exposure start timing of said exposure unit in a lateral direction, based on information on production variance of said exposure unit.

8. An image formation device in accordance with claim 7, wherein the information on production variance includes at least one of a variation in characteristic of said exposure unit, a variation in size of said exposure unit, and a variation in assembly accuracy of said exposure unit.

9. An image formation device in accordance with claim 7, wherein the information on production variance includes at least one of a variation in characteristic of a constituent of said exposure unit, a variation in size of a constituent of said exposure unit, and a variation in assembly accuracy of a constituent of said exposure unit.

10. An image formation device in accordance with claim 1, wherein said key unit includes at least a fixation unit, and
said control module adjusts a flow of electric current applied to a fixation lamp included in said fixation unit, based on information on production variance of said fixation unit.

11. An image formation device in accordance with claim 10, wherein the information on production variance includes at least one of a variation in characteristic of said fixation unit, a variation in size of said fixation unit, and a variation in assembly accuracy of said fixation unit.

12. An image formation device in accordance with claim 10, wherein the information on production variance includes at least one of a variation in characteristic of a constituent of said fixation unit, a variation in size of a constituent of said fixation unit, and a variation in assembly accuracy of a constituent of said fixation unit.

13. An image formation device in accordance with claim 1, wherein said key unit includes at least one of an image developer unit, a photoreceptor unit, and a transfer unit, and
said control module regulates a toner density of a resulting image, based on the acquired information on production variance.

14. An image formation device in accordance with claim 1, wherein the information on production variance includes at least one of a variation in characteristic of said key unit, a variation in size of said key unit, and a variation in assembly accuracy of said key unit.

15. An image formation device in accordance with claim 1, wherein the information on production variance includes at least one of a variation in characteristic of a constituent of said key unit, a variation in size of a constituent of said key unit, and a variation in assembly accuracy of a constituent of said key unit.

16. An image formation method that forms an image on a recording medium, such as paper, said image formation method comprising the steps of:
(a) acquiring information on production variance of at least one replaceable key unit included in an image formation device, which is stored in a storage element of said key unit; and
(b) controlling an image formation process of forming the image on the recording medium, based on the acquired information on production variance.

17. An image formation method in accordance with claim 16, wherein said step (b) adjusts a control parameter for controlling the image formation process based on the acquired information on production variance, and controls the image formation process with the adjusted control parameter.

18. An image formation method in accordance with claim 16, wherein said key unit includes at least one of a charge unit, a photoreceptor unit, an exposure unit, an image developer unit, a transfer unit, a feeder unit, and a fixation unit, and
said step (b) controls an operation of at least one of said key unit, based on information on production variance of said at least one of said key unit.

19. An image formation method in accordance with claim 16, wherein said key unit includes at least a secondary transfer unit, and
said step (b) adjusts a contact timing of said second transfer unit with an intermediate transfer member, based on information on production variance of said second transfer unit.

20. An image formation method in accordance with claim 16, wherein said key unit includes at least an exposure unit, and
said step (b) adjusts an exposure start timing of said exposure unit in a lateral direction, based on information on production variance of said exposure unit.

21. An image formation method in accordance with claim 16, wherein said key unit includes at least a fixation unit, and
said step (b) adjusts a flow of electric current applied to a fixation lamp included in said fixation unit, based on information on production variance of said fixation unit.

22. An image formation method in accordance with claim 16, wherein said key unit includes at least one of an image developer unit, a photoreceptor unit, and a transfer unit, and
said step (b) regulates a toner density of a resulting image, based on the acquired information on production variance.
